(19) United States
(12) Patent Application Publication
(10) Pub. No.: US 2025/0033089 A1
(43) Pub. Date: Jan. 30, 2025

(54) TARGETED SORTING OF PULP BOTTLES DURING RECYCLING

(71) Applicant: Krones AG, Neutraubling (DE)

(72) Inventors: Jörg ZACHARIAS, Koefering (DE); Angelika GROSSER, Emmerting (DE); Michael NEUBAUER, Grassau (DE); Michael AUBURGER, Donaustauf (DE)

(21) Appl. No.: 18/783,072

(22) Filed: Jul. 24, 2024

(30) Foreign Application Priority Data
Jul. 24, 2023 (DE) 10 2023 119 477.1

(51) Int. Cl. B07C 5/34

(52) U.S. Cl. CPC B07C 5/3404; B07C 5/3412; B07C 2501/0054

(57) ABSTRACT

Method for sorting a material flow of a sorting facility, comprising detecting, by means of a sensor system of the sorting facility, at least one unique feature of a material part that is transported in the material flow of the sorting facility, identifying, by means of a control apparatus of the sorting facility and based on the at least one feature, that the material part is a pulp container or part of a pulp container, and controlling a sorting apparatus of the sorting facility such that the material part is removed from the material flow.

### CROSS REFERENCE TO RELATED APPLICATION

The present application claims priority to German Patent Application No. 10 2023 119 477.1 filed on Jul. 24, 2023. The entire contents of the above-listed application are hereby incorporated by reference for all purposes.

### TECHNICAL FIELD

The disclosure relates to a method for sorting a material flow of a sorting facility and to an apparatus for sorting a material flow of a sorting facility.

### BACKGROUND

As an alternative, in particular to PET bottles, freely formable containers made of pulp are known in the prior art as a packaging solution for beverages. Manufacturing processes for such bottles are described, for example, in WO 2019/034707 A1, EP 3 642 414 B1 or EP 1 285 994 A1. However, such bottles are not yet widely used on the market.

Such bottles, like other packaging, are disposed of together with other packaging waste or recyclable materials. In Germany, for example, the bottles can be disposed of using the “green dot” system, the “yellow bag,” at sorting stations or at recycling or construction yards. Similar sorting and collection systems for household waste, both with and without a deposit, also exist in other countries. However, it is also possible for the bottles to be disposed of directly with the residual waste.

The current prior art does not yet provide a solution for recycling pulp bottles, their reuse, their material separation or their sortability during recycling.

The object of the present disclosure is therefore to provide a method which allows for the efficient recycling of bottles made of pulp material.

### SUMMARY

This object is achieved by a method as described herein.

The method is a method for sorting a material flow of a sorting facility and comprises:
Detecting, by means of a sensor system of the sorting facility, at least one uni que feature of a material part that is transported in the material flow of the sorting facility,
identifying, by means of a control apparatus of the sorting facility and based on the at least one feature, that the material part is a pulp container or part of a pulp container, and
controlling a sorting apparatus of the sorting facility such that the material part is removed from the material flow.

The sorting facility can in particular be a sorting facility for waste or recyclable materials. The sorting facility can in particular be part of a recycling facility for beverage containers. The material flow can in particular be a mixed material flow, wherein this is understood to mean a material flow that comprises different types of material. For example, a mixed material flow may include plastics parts, paper parts, pulp parts, metal parts, etc.

Here and hereinafter, the term “pulp container” refers to a container made from pulp. However, it is possible for a pulp container to comprise other materials, for example for a coating. The pulp may comprise fibers, in particular fibers of natural origin. The fibers may contain lignin and/or quinine. The fibers may, for example, comprise cellulose fibers, fibers of conifers, of leafy woody plants and/or plane trees and/or grasses, reeds and/or bamboo or the like. The fibers may comprise silk threads, spider silk, algae, natural fibers (such as cup-plant fibers, hemp, maize, cotton), banana peel, banana leaves, orange peel, grass, straw, potato starch or processed cow dung. It is also possible to provide cellulose fibers which originate from a process by which they were artificially grown. In the event of material bottlenecks of wood as the basic material for a fluid mass with fibers, these alternative materials can completely or partially replace the basic material. The fibers can comprise fiber mixtures of non-wood material, for example cotton, hemp and/or textile fibers.

By specifically identifying the material part based on its unique feature and then removing the material part, it is possible to collect material that is as pure as possible for subsequent recycling of the material. Herein, recycling means in particular the reuse or further use of the material. Thermal utilization, however, is not considered recycling. In other words, recycling means the reuse or further use of the material without thermal recycling.

The material part removed from the material flow can, for example, be transferred to a corresponding collecting tank. It is also possible for the material part to be transferred into an unmixed material flow, for example onto a corresponding conveyor belt.

In particular, identifying that the material part is part of a container made of pulp can be done automatically.

The sensor system may comprise an optical sensor, for example a camera. Alternatively or additionally, the sensor system may comprise a receiver for electromagnetic waves in the long-wave and/or short-wave and/or ultra-high frequency and/or microwave range. It is further possible for the sensor system to comprise a source of infrared and/or UV radiation and/or a sensor for infrared and/or UV radiation. It is further possible for the sensor system to comprise a sensor for measuring magnetic and/or electric fields or for measuring changes in such fields. The sensor system can have a combination of different sensor types.

A reliable detection of the unique feature can be achieved with a sensor system having one or more such sensors.

Sensors of the sensor system can be arranged above the material flow. Sensors of the sensor system can alternatively or additionally be arranged laterally of the material flow. It is also possible for sensors of the sensor system to be arranged below a transport apparatus, e.g., a conveyor belt, on which the material flow is conveyed.

The at least one unique feature may comprise a signal emitted by a transponder, in particular an RFID transponder, which is part of the material part. Suitable transponders can be very small and arranged at different places on the pulp container. For example, they can also be located inside the container or even in the container wall. As a result, the transponders can be installed inconspicuously, i.e., without compromising the design of the pulp container, while still allowing for the pulp container to be clearly identified. Furthermore, the transponder signal can be reliably detected even if the view of the material part is obscured, for example by other waste or the like.

The at least one unique feature can further comprise an engraving present on the material part. Alternatively or additionally, the at least one unique feature can comprise a three-dimensional structure on the material part.

Alternatively or additionally, the at least one unique feature can comprise a print on the material part, in particular a print applied directly to a surface of the material part, wherein the print can be applied to any part of the surface. Here, it is possible in particular for the print to be at least partially applied to the material part with an ink that is not visible to the human eye. This can also allow for a clear identification of the material part without affecting the design of the pulp container.

Alternatively or additionally, the at least one unique feature can comprise a marking, in particular a holographic marking, on the material part. Alternatively or additionally, the at least one unique feature can comprise a code, in particular a QR code and/or a bar code, which is applied to the material part. It is further possible for the at least one unique feature to comprise a digital watermark on the material part. A digital watermark is understood to be a marking that is interwoven with another pattern, for example a print, but cannot be directly perceived by a human. For example, a pixel pattern may be hidden in a print, which pixel pattern can be detected and identified as a watermark only through digital analysis of the print.

One of the at least one unique features can be arranged on a side of the material part which corresponds to an outer side of a pulp container, in particular a bottle. It is further possible for one of the at least one unique features to be arranged on a side of the material part which corresponds to an inner side of a pulp container, in particular a bottle.

It is possible for the pulp container to have several of the unique features mentioned above. The pulp container may have different types of unique features, but it is also possible for the pulp container to have one type of a different feature in several places. A combination of these variants is also possible. It is furthermore possible for the sensor system to be configured to detect several of the unique features mentioned above. Because the pulp container has several unique features and the sensor system is configured to detect these several unique features, the material part can be clearly identified as belonging to the pulp container, even if the material part is partially obscured or represents only part of the pulp container, for example if the pulp container is broken.

For example, it is possible for the pulp container to have a print that fluoresces when exposed to UV light. At the same time, one or more RFID transponders can be arranged on or in the pulp container, in particular in places not covered by the print. The sensor system can comprise a UV lamp that causes the print to fluoresce, a camera that detects the fluorescent light, and an RFID receiver. In this case, parts of the pulp container on which the print is present can be identified by means of the detected fluorescent radiation, while other parts of the pulp container can be identified by detecting the signal from the RFID transponder.

Furthermore, the control apparatus can be configured to perform the identification, which shows that the material part is part of a pulp container, based only on part of the at least one unique feature. For example, it is possible for the at least one unique feature to comprise a printed pattern and/or a three-dimensional structure, and for the control apparatus to be configured to recognize the pattern or structure even if the sensor system only partially detects the pattern or structure. For this purpose, the control apparatus can be configured to use corresponding pattern recognition systems. It is furthermore possible for the control apparatus to be configured to use artificial intelligence or machine learning methods for this.

In this way, reliable identification of the material part can be ensured even in those cases where the material part cannot be detected fully, or can be detected only partially covered, by the sensor system.

It is possible for the control apparatus to be configured to identify specific properties of the pulp container based on the unique feature. The specific properties can in particular relate to the material composition of the pulp. In particular, the control apparatus can be configured to detect whether the pulp has one or more of the above-mentioned fibers. Alternatively or additionally, the specific properties can relate to a best before date of the pulp container and/or dimensions of the pulp container and/or a closure type of the pulp container and/or a calorific value of the pulp container and/or a color of the pulp container. It is possible for the specific properties to be encoded in the unique feature. By identifying specific properties of the pulp container based on the unique feature, the collection of material that is as pure as possible for subsequent recycling of the material can be further improved.

It is possible for the control apparatus to be configured to detect the size of the material part based on the data from the sensor system. For example, it is possible for the control apparatus to be configured to process image data in order to determine the size of the material part. For example, the size can be determined based on a comparison of the size of a print or part of a print with the detected contours of the material part. In order to save computing resources, the size may be determined only after the material part has been identified based on at least one unique feature.

Controlling the sorting apparatus can comprise controlling a compressed air apparatus to remove the material part from the material flow. Relatively light pulp material parts can simply be blown out of the material flow by means of a suitable compressed air apparatus. The compressed air apparatus can furthermore be controlled based on a determined size of the material part. It is thus possible for the strength of a compressed air flow to be selected to be lesser for a small part than for a larger part. Alternatively or additionally, it is possible that controlling the sorting apparatus comprises controlling another discharge element, for example a pusher.

The disclosure further provides an apparatus for sorting a material flow of a sorting facility, wherein the apparatus is configured to perform a method having one or more of the features described above.

The disclosure furthermore provides a pulp container having one of the at least one unique features described above.

### BRIEF DESCRIPTION OF THE DRAWINGS

Further features and advantages of the disclosure are explained below with reference to the exemplary figures. In the drawings:

FIG. 1 schematically shows a sorting facility for a material flow;

FIG. 2 schematically shows a container; and

FIG. 3 shows a flowchart of a method for sorting a material flow.

### DETAILED DESCRIPTION

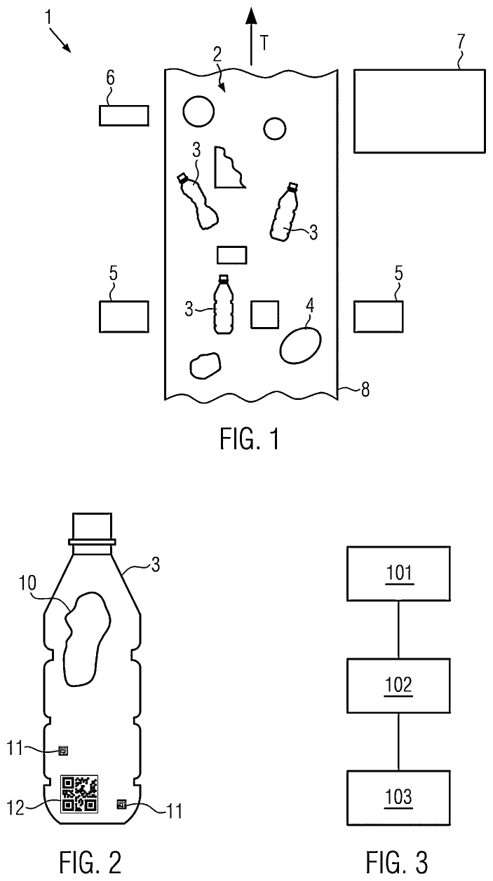

FIG. 1 schematically shows a sorting facility 1 for a material flow 2, which is a sorting facility in a waste management or recycling facility. The material flow 2 contains pulp containers 3 or parts of pulp containers 3. The material flow 2 further contains objects 4 made of other materials.

The material flow 2 is transported on a conveyor belt 8 in the direction of the arrow T. The pulp containers 3 or parts of pulp containers 3 and the objects 4 are guided past sensors 5 of a sensor system. In the arrangement shown, the sensors 5 are arranged on both sides of the conveyor belt 8. However, there may be additional sensors above and/or below the conveyor belt. A compressed air apparatus 6 and a collecting tank 7 are located downstream of the sensors 5. The pulp containers 3 or parts of the pulp containers 3 can be blown from the material flow 2 into the collecting tank 7 by means of the compressed air apparatus 6. Alternatively, the pulp containers 3 or parts of the pulp containers 3 can be transferred from the material flow 2 to a further conveyor belt not shown in FIG. 1.

The sensors 5 and the compressed air apparatus 6 are connected to a control apparatus (not shown) for data exchange. The control apparatus is configured to evaluate the sensor data from the sensors 5 and to control the compressed air apparatus 6 based on the sensor data. The control apparatus may include a processor and memory for holding instructions for carrying out the methods as described herein, and the processor may be coupled with the sensor for receiving sensed data from the sensors. The processor may also be coupled with actuators for adjusting the sorting apparatus via one or more actuators of the sorting apparatus.

The sensors 5 are configured to detect unique features of the pulp containers 3 or parts of the pulp containers 3.

FIG. 2 schematically shows a pulp container 3. The pulp container 3 has several unique features, namely a print 10, two transponders 11 and a QR code 12. The print 10 consists at least partially of an ink that is not visible to the human eye. Each of the unique features identifies the pulp container 3 as a container made of pulp.

FIG. 3 schematically shows a flowchart of a method for sorting a material flow in a sorting facility.

In step 101, a sensor system of the sorting facility is used to detect at least one unique feature of a material part that is transported in the material flow of the sorting facility. In step 102, a control apparatus of the sorting facility uses the at least one feature to identify that the material part is part of a pulp container. In step 103, a sorting apparatus of the sorting facility is controlled such that the material part is removed from the material flow.

1. A method for sorting a material flow of a sorting facility, comprising:
detecting, by means of a sensor system of the sorting facility, at least one unique feature of a material part that is transported in the material flow of the sorting facility;
identifying, by means of a control apparatus of the sorting facility and based on the at least one unique feature, that the material part is a pulp container or part of the pulp container; and
controlling a sorting apparatus of the sorting facility such that the material part is removed from the material flow.

2. The method according to claim 1, wherein the sensor system comprises an optical sensor.

3. The method according to either claim 1, wherein the sensor system comprises a receiver for electromagnetic waves in a long-wave and/or a short-wave and/or ultra-high frequency and/or microwave range.

4. The method according to claim 1, wherein the sensor system comprises a source of infrared and/or UV radiation, and/or wherein the sensor system comprises a sensor for infrared and/or UV radiation.

5. The method according to claim 1, wherein the at least one unique feature comprises a signal emitted by an RFID transponder of the material part.

6. The method according to claim 1, wherein the at least one unique feature comprises an engraving present on the material part.

7. The method according to claim 1, wherein the at least one unique feature comprises a three-dimensional structure on the material part.

8. The method according to claim 1, wherein the at least one unique feature comprises a print on the material part.

9. The method according to claim 8, wherein the print comprises a part applied to the material part with an ink that is not visible to the human eye.

10. The method according to claim 1, wherein the at least one unique feature comprises a marking on the material part.

11. The method according to claim 1, wherein the at least one unique feature comprises a code.

12. The method according to claim 1, wherein the at least one unique feature comprises a digital watermark on the material part.

13. The method according to claim 1, wherein controlling the sorting apparatus comprises controlling a compressed air apparatus to remove the material part from the material flow.

14. An apparatus for sorting the material flow of the sorting facility, wherein the apparatus is configured to perform the method according to claim 1.

15. The method according to claim 10, wherein the marking is a holographic marking.

16. The method according to claim 11, wherein the code is a QR code.

17. The method according to claim 11, wherein the code is a bar code.
